(19) United States
(12) Patent Application Publication
(10) Pub. No.: US 2002/0194319 A1
(43) Pub. Date: Dec. 19, 2002

(54) Automated operations and service monitoring system for distributed computer networks

(76) Inventor: Scott D. Ritche, Centennial, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 09/880,740

(22) Filed: Jun. 13, 2001

(51) Int. Cl. G06F 15/173

(52) U.S. Cl. 709/223; 709/224

(57) ABSTRACT

A network service monitoring system including a monitoring tool for processing error alerts issued during distribution of application packages to network client devices. The monitoring tool determines if the fault that caused generation of an error alert originated with a network device or with a communication pathway in the network. The monitoring tool then remotely performs diagnostics specific to devices or to communication pathways, and if appropriate based on diagnostics results, calls a service ticket mechanism to automatically issue a job ticket to a maintenance center responsible for the affected device or communication pathway. Preferably, the monitoring tool provides real time or ongoing monitoring of communication pathway problems including determining a downtime and updating a display on a user interface of existing availability. The service ticket mechanism is configured for automatically addressing common errors in issued job tickets.

### BACKGROUND OF THE INVENTION

1. Field of the Invention

The present invention relates, in general, to automated software distribution and operations monitoring in a distributed computer network, and, more particularly, to a system and method for monitoring software distribution and system operations to automatically diagnose and correct select server and network problems and to issue electronic service requests or service job tickets to initiate maintenance or repair efforts for specific computer or data communication devices in the distributed computer network.

2. Relevant Background

Distributed computer networks with de-centralized software environments are increasingly popular designs for network computing. In such distributed computer networks, a copy of a software program (i.e., an application package such as Netscape™, Staroffice™, and the like) is distributed over a data communications network by a master or central network device for installation on client network devices that request or require the particular application package. The master network device may be a server or a computer device or system that maintains current versions and copies of applications run within the distributed computer network.

When an application is updated with a new version or with patches to correct identified bugs, the master server functions to distribute updated application packages through one or more intermediate servers and over the communications network to the appropriate client network devices, i.e., the devices utilizing the updated application. The client network device may be an end user device, such as a personal computer, computer workstation, or any electronic computing device, or be an end user server that shares the application with a smaller, more manageable number of the end user devices within the distributed computer network. In this manner, the distributed computer network provides stand-alone functionality at the end user device and makes it more likely that a single failure within the network will not cripple or shut down the entire network (as is often the case in a centralized environment when the central server fails).

While these distributed computer networks provide many operating advantages, servicing and maintaining client network devices during software installation and operation are often complicated and costly tasks. The networks often include large numbers of client network devices, such as intermediate servers, end user servers, and end user devices upon which applications must be installed and which must be serviced when installation and/or operation problems occur. In addition to the large quantity of devices that must be serviced, the client network devices may be located in diverse geographic regions as the use of the Internet as the distribution path enables application packages to be rapidly and easily distributed worldwide. The master server is typically located in a geographic location that is remote from the client network devices, which further complicates servicing of the devices as repair personnel need to be deployed at or near the location of the failing device such as from a regional or onsite service center. Efforts have been made to facilitate effective application package distribution and installation in numerous and remotely-located client network devices (see, for example, U.S. Pat. No. 6,031,533 to Peddada et al.). However, existing software distribution systems do not meet the industry need for effective monitoring and servicing of client network devices during and after the distribution of application packages.

Generally, during operation of a distributed computer network, a master server executing a distribution tool operates to distribute an application package over the communications network through intermediate servers to a number of remote end user servers and end user devices. The receiving devices may be listed as entries in a network distribution database which includes a delivery address (e.g., domain and/or other information suiting the particular communications network), a client node network name, package usage data (e.g., which packages are used or served from that client network device), and other useful package distribution information. A distribution list is created for a particular application, and the distribution tool uses the list as it transmits copies of the application package to the appropriate end user servers and end user devices for installation.

If delivery fails, installation fails, or if other problems occur, the affected or upstream client network devices transmit error messages back to the distribution tool. In a relatively large network, the distribution tool may receive hundreds, thousands, or more error messages upon the distribution of a single application package. In many distributed computer networks, a service desk device or service center (e.g., a computer system or a server operated by one or more operators that form a service team) is provided to respond to software installation and other network operating problems. In these networks, the distribution tool gathers all of the error messages and transmits them to the service desk as error alerts. For example, the distribution tool may send e-mail messages corresponding to each error message to the e-mail address of the service desk to act on the faults, errors, and failures in the network. The operator(s) of the service desk must then manually process each e-mail to determine if service of the network or client network devices is required, which service group is responsible for the affected device, and what information is required by the service department to locate the device and address the problem. If deemed appropriate by the operator, the service desk operator manually creates (by filling in appropriate fields and the like) and transmits an electronic service request, i.e., service job ticket, to a selected service group to initiate service. The receiving service group then processes the job ticket to assign appropriate personnel to fix the software or hardware problem in the network device.

Problems and inefficiencies are created by the use of the existing service management methods. Generally, the error alerts provide little or no indication as to whether the problem is at a specific server or is data communication network problem. This makes it difficult to create a service request with adequate information or to direct the service request to the correct service group or location. Further, existing service management methods typically have no or little diagnostic and error correction capabilities, which forces the system operator to rely on the content of the error alert for accuracy and content and to issue service requests even if the problem can be addressed remotely.

While some efforts have been made to automate the creation of service requests, manual processing is still the normal mode of operation. The manual processing of the error alerts from the distribution system can rapidly overwhelm the service desk resulting in service delays or require large numbers of personnel to timely respond resulting in increased service costs. The manual processing of the error alerts also results in errors as the human operator may incorrectly fill out a job ticket with insufficient and/or inaccurate information making repair difficult or impossible. The job ticket may also be accidentally assigned to the wrong service group.

Additionally, numerous job tickets may be issued based on a single network problem. For example, a problem with an Internet connection or service provider may result in numerous error messages being transmitted to the distribution tool, which in turn issues error alerts to the service desk, because distribution and installation failed at all client network devices downstream from the true problem. Due to the large number of error alerts being received at the service desk, an operator would have great difficulty in tracking alerts and/or identifying specific problems, and in this example, would most likely transmit a job ticket for each device for which installation failed. The service group may respond to the job ticket by wasting time inspecting the device referenced in the job ticket only to find no operating problem because the true problem occurred upstream within the network.

The service group may further be bogged down as it receives multiple job tickets for the same device that must be assigned and/or cleared (e.g., a single client network device may issue more than one error message upon a failure to install an application package). The number of error messages and error alerts with corresponding job tickets may increase rapidly if the distribution tool acts to retry failed transmittals and installations without filtering the error alerts it transmits to the service desk. Clearly, the existing service management techniques result in many “false” job tickets being issued that include incorrect device and failure/problem information, that request repair of a device that is not broken or offline, and that request repair or service for a device whose problems were previously addressed in another job ticket. Each false job ticket increases service costs and delays responses to true client network device problems.

Hence, there remains a need for an improved method and system for providing service support of software distribution in a distributed computer network. Such a method and system preferably would be useful within a geographically disburse network in which the central or master server is located remote from the end user servers, end user devices, and service centers. Additionally, such a method and system would reduce the cost of monitoring and assigning service requests to appropriate service centers or personnel while differentiating between server or network device problems and network or communication problems. The method and system preferably would provide enhanced diagnostics of distribution and operating errors within the distributed computer network and also provide some error correction capabilities to reduce the overall number of service request being created and issued.

### SUMMARY OF THE INVENTION

The present invention addresses the above discussed and additional problems by providing a service monitoring system including a monitoring tool for processing numerous error alerts issued during distribution of application packages to network client devices in a network. According to one aspect of the invention, the monitoring tool is configured to determine if the fault or problem that caused the generation of an error alert originated with a network device operating problem or with a fault in a communication pathway in the network. The monitoring tool then remotely performs diagnostics specific to devices or to communication pathways, and if appropriate based on diagnostic results, calls a service ticket mechanism to automatically issue a job ticket to a maintenance center responsible for the affected device or communication pathway. Preferably, the monitoring tool is uniquely adapted for providing real time and/or ongoing monitoring of communication pathway problems including determining a downtime and updating a display on a user interface of existing availability and downtimes. Further, the service ticket mechanism is configured for automatically modifying data in an issued job ticket to resolve errors detected by a maintenance center (e.g., invalid or incorrect device or fault information and other often experienced job ticket errors).

More particularly, a computer-implemented method is provided for monitoring the processing of and responding to error alerts created during package distribution on a computer network. The method includes receiving an error alert and processing the error alert to create a subset of error data from failure information in the error alert. A determination is made of the cause of the error alert, i.e., whether a device or a communication pathway in the network is faulting, by performing remote, initial diagnostic tests (such as running Packet Internet Groper (PING) on an IP addresses on either side of the reported “down” device). Based on this determination, device-specific or network-specific diagnostics are performed to gather additional service information. A job ticket is then created using the parsed failure information and the information from the remote diagnostics. If the error alert was caused by a network problem, the method includes determining the last accessible IP address and then determining if a threshold limit has been exceeded for that location prior to creating the job ticket to reduce the volume of issued job tickets.

According to another aspect of the invention, a service monitoring method is provided that includes receiving an error alert for a device in a computer network. The error alert includes identification and network location information for the device. The method continues with creating a check engine to periodically or substantially continuously transmit a signal to the device to determine if the device is active (such as running PING on the device). When the check engine determines that the device is active, the method includes transmitting a “device active” message to a user interface for display (which may include sending e-mail alerts to maintenance personnel or monitoring system operators). The method may include determining a down time for the device based on information gathered by the check engine and transmitting this down time to the user interface.

According to yet another aspect of the invention, a method is provided for monitoring operation and maintenance of communication pathways and network devices in a computer network. The method includes receiving an error alert from one of the network devices and processing the error alert to retrieve a set of service information including identification of an affected device. Next, the method involves determining a maintenance center responsible for the affected device based on the retrieved service information. A job ticket template is then selected and retrieved based on the service information (such as based on the indicated fault type or geographic location). A job ticket is created for the identified or affected device by combining the retrieved job ticket template and at least a portion of the service information. The job ticket is then transmitted to the corresponding maintenance center. The method preferably includes responding to the receipt of job tickets returned with error messages by modifying at least some of the information in the job ticket and transmitting the modified job ticket back to the maintenance center.

### BRIEF DESCRIPTION OF THE DRAWINGS

FIG. 1 illustrates a service monitoring system with a monitoring center comprising a monitoring tool and other components for automated processing of error alerts issued during software distribution to diagnose errors, correct selective errors, and selectively and automatically create and issue job tickets;

FIG. 2 is a flow diagram showing operation of the monitoring tool of the monitoring center of FIG. 1 to process error alerts, perform diagnostics selectively on servers or client network devices and networks/links, and when useful, to call the service ticket mechanism to issue a service request or ticket; and

FIG. 3 is a flow diagram showing exemplary operation of the service ticket mechanism according to the invention.

### DETAILED DESCRIPTION OF THE PREFERRED EMBODIMENTS

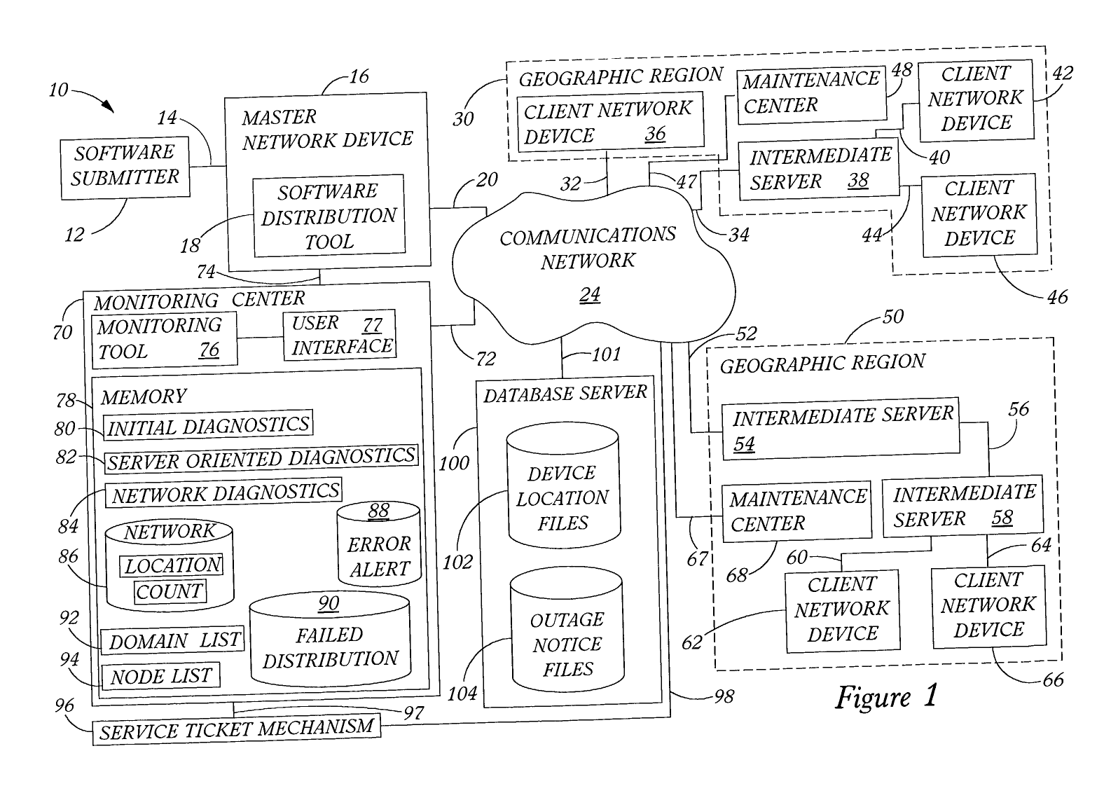

FIG. 1 illustrates one embodiment of a service monitoring system 10 useful for providing automated monitoring of operation of a distributed computer network and particularly, for processing error alerts arising during software distribution throughout the computer network. In this regard, a monitoring center 70 with a monitoring tool 76 is provided that is configured to, among other tasks, receive error alerts, perform server and network diagnostics (i.e., differentiate between server or network device problems and network communication problems and select specific diagnostic tools based on such differentiation), retrieve useful information from the alerts, determine when and whether a job ticket should be created, and based on such determination to pass the parsed error alert information to a service ticket mechanism 96.

The service ticket mechanism 96 automatically downloads and edits a job ticket template, addresses commonly encountered errors prior to submitting the job ticket (i.e., errors in job tickets that would cause the maintenance center to reject or return the job ticket as unprocessable), retries transmittal of the job ticket as necessary up to a retry limit, and handles other administrative functions to reduce operator involvement. In addition to requesting a job ticket, the monitoring center 70 preferably functions to monitor down devices and networks/network paths to determine when the devices and/or network paths become operable or available. A spawned job or operating alert is then transmitted by the monitoring center 70 reporting the change in availability and providing other information (such as how long the device or network path was down or out of service).

The functions and operation of the monitoring center 70 with its monitoring tool 76 and the service ticket mechanism 96 are described in a client/server, decentralized computer network environment with error alerts and job tickets being transmitted in the form of e-mails. While this is a highly useful implementation of the invention, those skilled in the computer and networking arts will readily appreciate that the monitoring tool 76 and service ticket mechanism 96 and their features are transferable to many data transfer techniques. Hence, these variations to the exemplary service monitoring system 10 are considered within the breadth of the following disclosure and claims.

As illustrated, the service monitoring system 10 includes a software submitter 12 in communication with a master network device 16 via data communication link 14. The software submitter 12 provides application packages to the master network device 16 for distribution to select client network devices or end users. In the following discussion, network devices, such as software submitter 12 and master network device 16, will be described in relation to their function rather than as particular electronic devices and computer architectures. To practice the invention, the computer devices and network devices may be any devices useful for providing the described functions, including well-known data processing and communication devices and systems such as personal computers with processing, memory, and input/output components. Many of the network devices may be server devices configured to maintain and then distribute software applications over a data communications network. The communication links, such as link 14, may be any suitable data communication link, wired or wireless, for transferring digital data between two electronic devices (e.g., a LAN, a WAN, an Intranet, the Internet, and the like). In a preferred embodiment, data is communicated in digital format following standard protocols, such as TCP/IP, but this is not a limitation of the invention as data may even be transferred on removable storage media between the devices or in print form for later manual or electronic entry on a particular device.

With the application package, the software submitter 12 generally will provide a distribution list (although the master network device 16 can maintain distribution lists or receive requests from end user devices) indicating which devices within the system 10 are to receive the package. The master network device 16, e.g., a server, includes a software distribution tool 18 that is configured to distribute the application package to each of the client network or end user devices (e.g., end user servers, computer work stations, personal computers, and the like) on the distribution list. Configuration and operation of the software distribution tool 18 is discussed in further detail in U.S. Pat. No. 6,031,533 to Peddada et al., which is incorporated herein by reference. Additionally, the software distribution tool 18 may be configured to receive error alerts (e.g., email messages) from network devices detailing distribution, installation, and other problems arising from the distribution of the application package.

To distribute the application package and receive error alerts, the master network device 16 is connected via communication link 20 to a communications network 24, e.g., the Internet. The service monitoring system 10 may readily be utilized in very large computer networks with servers and clients in many geographic areas. This is illustrated in FIG. 1 with the use of a first geographic region 30 and a second geographic region 50. Of course, the master network device 16 and the monitoring center 70 (discussed in detail below) may be in these or in other, remote geographic regions interconnected by communications network 24. For example, the master network device 16 and monitoring center 70 may be located in one region of the United States, the first geographic region 30 in a different region of the United States, and the second geographic region may encompass one or more countries on a different continent (such as Asia, Europe, South America, and the like). Additionally, the system 10 may be expanded to include additional master network devices 16, monitoring centers 70, and geographic regions 30, 50.

As illustrated, the first geographic region 30 includes a client network device 36 linked to the communications network 24 by link 32 and an intermediate server 38 linked to the communications network 24 by link 34. This arrangement allows the software distribution tool 18 to distribute the application package to the client network device 36 (e.g., an end user server or end user device) and to the intermediate server 38 which in turn distributes the application package to the client network devices 42 and 46 over links 40 and 44. If problems arise during distribution or operations, a first maintenance center 48 is provided in the first geographic region 30 to provide service and is communicatively linked with link 47 to the communications network 24 to receive maintenance instructions from the service ticket mechanism 96 (i.e., electronic job tickets), as will be discussed in detail. Similarly, the second geographic region 50 comprises a second maintenance center 68 communicatively linked via link 67 to the communications network 24 for servicing the devices in the region 50. As illustrated, an intermediate server 54 is linked via link 52 to the communications network 24 to receive the distributed packages and route the packages as appropriate over link 56 to intermediate server 58, which distributes the packages over links 60 and 64 to client network devices 62 and 66.

Many problems may arise during distribution of software packages by the software distribution tool 18. An error, failure, or fault may occur due to communication or connection problems within the communications network 24 or on any of the communication links (which themselves may include a data communications network such as the Internet), and these errors are often labeled as connection errors or communication pathway problems (rather than network device problems or faults). An error may occur for many other reasons, including a failure at a particular device to install a package or a failure of a server to distribute, and these errors are sometimes labeled as failed package and access failure errors. Many other errors and failures of package distribution will be apparent to those skilled in the art, and the system 10 is typically configured to monitor in real time such errors and to process and diagnose these errors.

Preferably, the software distribution tool 18 and/or the intermediate servers and client network devices are configured to create and transmit error alerts upon detection of a distribution error or fault (such as failure to complete the distribution and installation of the package). Typically, the intermediate servers immediately upstream of the affected device (server or end user device) are adapted to generate an error alert, e.g., an e-mail message, comprising relevant information to the package, the location of the problem, details on the problem, and other information. The error alert is then transmitted to the master network device 16, which in turn transmits the error alert to the monitoring center 70 for processing and monitoring with the monitoring tool 76. Alternatively, the error alert may be transmitted directly to the monitoring center 70 for processing.

For example, the software distribution tool 18 may initiate distribution of a package to the client network device 46 but an error may be encountered that prevents installation. In response, the intermediate server 38 generates an error alert to the master network device 16 providing detailed information pertaining to the problem. The master network device 16 then either sends an e-mail message via the communications network 24 to the monitoring center 70 or directly contacts the monitoring center 70 via link 74 (such as by use of a script or other tool at the master network device 16). In some situations, the intermediate server 38 may attempt connection and distribution to the client network device 46 a number of times, which may result in a corresponding number of error alerts being issued for a single problem at a single network device 46 or on a communication pathway (e.g., on link 44).

Significantly, the service monitoring system 10 includes the monitoring tool 76 within the monitoring center 70 to automatically process the created error alerts to efficiently make use of resources at the maintenance centers 48, 68. In practice, the monitoring tool 76 may comprise a software program or one or more application modules installed on a computer or computer system, which may be part of the monitoring center 70 or maintained at a separate location in communication with the monitoring center 70. The error alerts generated by the various server and client network devices are routed to the monitoring center 70 over the communications network 24 via link 72 directly from the servers and client network devices or from the software distribution tool 18 (or may be transmitted via link 74). As discussed previously, the error alerts may take a number of forms, and in one embodiment, comprise digital data contained in an e-mail message that is addressed and routed to the network address of the monitoring center 70.

The monitoring tool 76 is configured to process the received error alerts to parse important data. Memory 78 is included to store this parsed data in error alert files 88 (as well as other information as will be discussed). Preferably, the information stored is parsed from the valid error alerts to include a smaller subset of the information in the error alerts that is useful for tracking and processing the error alerts and for creating job tickets. The memory 78 may further include failed distribution files 90 for storing information on which packages were not properly distributed, which devices did not receive particular packages, and the like to allow later redistribution of these packages to proper recipient network devices.

According to an important aspect of the invention, the monitoring tool 76 is configured to differentiate between server or other client network device faults or problems and communication pathway faults (such as in the communications network 24 or in a link) and to perform diagnostics remotely on the device or pathway. In this regard, the memory 78 includes initial diagnostics 80 (which may be run on network devices and on communication pathways), server-oriented diagnostics 82 (to be run on server/client devices), and network diagnostics 84 (to run when a communication pathway is determined to be inoperable or faulting).

According to another aspect of the invention, the monitoring tool 76 is configured to provide real time monitoring of network and other errors. To support this function, the monitoring center 70 includes a user interface 77, which may be a graphical user interface or a command line interface, for displaying current status of faults and issued tickets (e.g., actions taken and the like). The memory 78 also includes network database files 86 with records indicating the location of identified faults and a running count of errors noted at that location. The graphical user interface 77 may be utilized to allow an operator of the center 70 to enter or modify thresholds used to compare with the count for determining when a job ticket should be issued.

In practice, the threshold limits are utilized by the monitoring tool 76 for determining when to call the service ticket mechanism 96 to create and issue a job ticket based on error alerts received for that location. Once a threshold limit is exceeded, the service ticket mechanism 96 is called to create and issue a service ticket for that network location. Briefly, the threshold limits are predetermined or user-selectable numbers of error alerts regarding a particular location that are to be received before a job ticket will be issued to address the problem.

In one embodiment, the threshold limits may be set and varied for each type of problem or fault and may even be varied by device, region, or other factors. For example, it may be desirable to only issue a job ticket after connection has been attempted four or more times over a selected period of time. In this manner, transient problems within the communications network 24 or in various data links that result in partial distribution failing and error alerts being created may not necessarily result in “false” job tickets being issued (e.g., the problem is in the network, such as a temporary data overload at an ISP or extremely short term disconnection, rather than a “hard failure” at the network device). For device errors, it may be desirable to set a lower threshold limit, such as one if the problem was a failed installation upon a particular device. Of course, it should be understood that the memory 78 and the monitoring tool 76 may be located on separate devices rather than on a single device as illustrated as long as monitoring tool 76 is provided access to the information illustrated as part of memory 78 (which may be more than one memory device).

According to another important aspect of the monitoring tool 76, the tool 76 is configured to determine whether the problem can be explained by causes that do not require service prior to calling the service ticket mechanism 96. For example, network operations often require particular devices to be taken offline to perform maintenance or other services. Often, a network system will include a file or database for posting which network devices are out of service for maintenance or are known to be already out of service due to prior detected faults resulting in previously issued automatic or manual job tickets. In this regard, the service monitoring system 10 includes a database server 100 linked to the communications network 24 via link 101 having an outage notice files database 104. The monitoring tool 76 is adapted for performing a look up within the outage notice files 104 to verify that the device is online prior to creating and issuing a job ticket. This outage checking eliminates issuing many unnecessary job tickets which if issued add an extra administrative burden on the maintenance centers 48, 68.

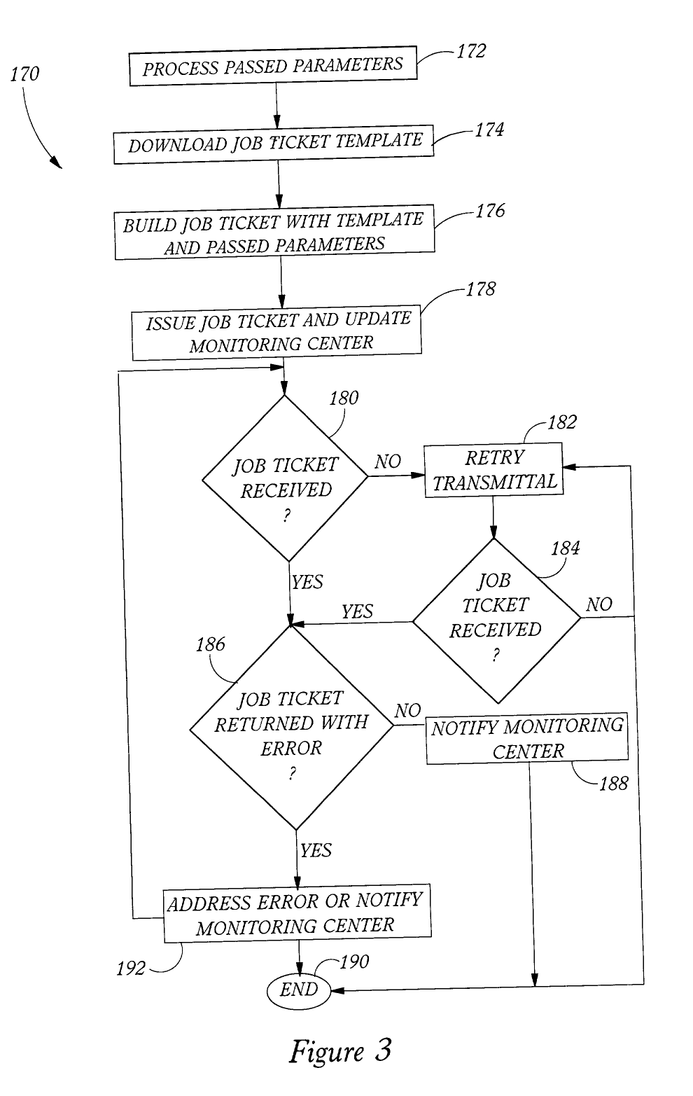

Once the monitoring tool 76 determines a job ticket should be issued, the tool 76 acts to pass the parsed and sorted data from the error alert(s) to the service ticket mechanism 96, which functions to automatically select a proper template, build the job ticket, resolve common ticket creation errors, and then issue the job ticket via link 98 and communications network 24 to the proper maintenance center 48, 68. As will become clear from the discussion of the operation of the service ticket mechanism 96 with reference to FIG. 3, further processing may be desirable to further enhance the quality of the issued job tickets.

For example, it is preferable that the information included in the job tickets be correct and the job tickets be issued to the appropriate maintenance centers 48, 68. In this regard, the database server 100 may include device location files 102 including location information for each device in the network serviced by the system 10. With this information available, the service ticket mechanism 96 preferably functions to perform searches of the device location files 102 with the location and device name information parsed from the error alerts to verify that the location information is correct. The verified location information is then included by the service ticket mechanism 96 in created and transmitted job tickets. Of course, the outage notice files 104 and device location files 102 may be stored separately and in nearly any type of data storage device. Further processing steps to handle a variety of administrative details are preferably performed by the service ticket mechanism 96 as part of creating and issuing a job ticket and are discussed in detail with reference to FIG. 3.

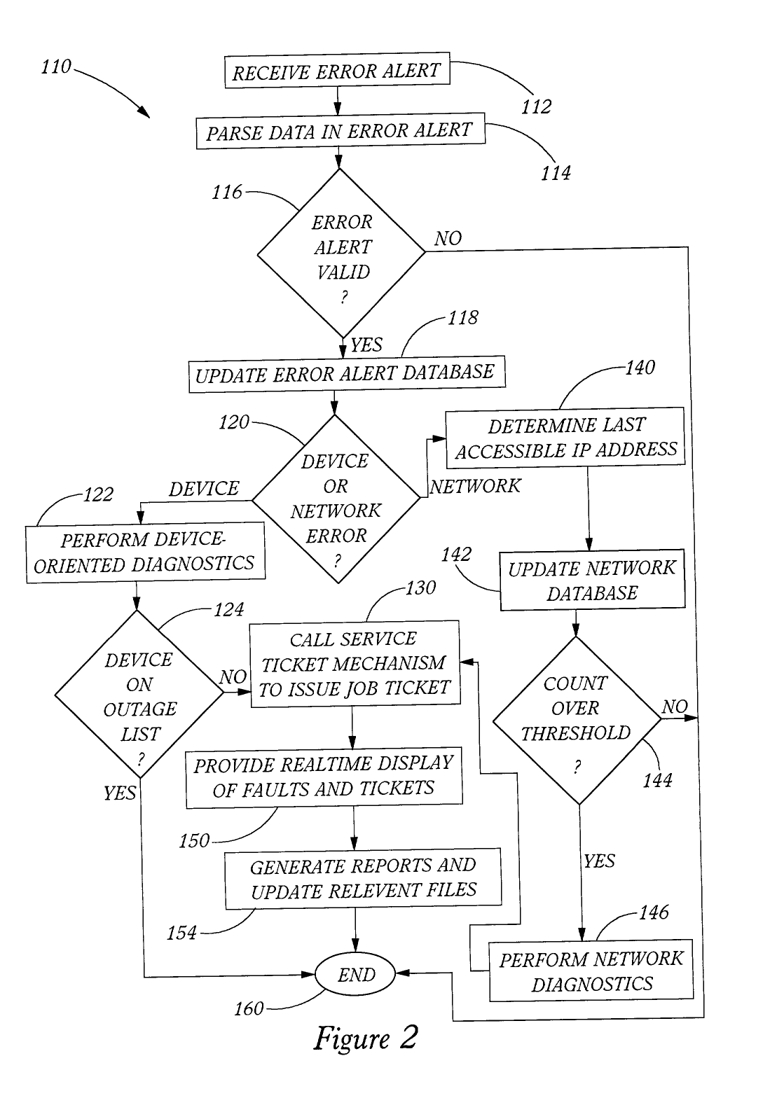

The operation of the monitoring tool 76 within the system monitoring system 10 will now be discussed in detail with reference to FIG. 2. Exemplary features of an operations and maintenance monitoring process 110 carried out by the monitoring tool 76 during and after distribution of software packages (or general operations of the system 10) are illustrated. The process 110 begins at 112 with the receipt of an error alert by the monitoring tool 76. As discussed previously, the error alert received at 112 is generally in the form of an email message but the monitoring tool 76 may readily be adapted to receive error alerts having other formats.

At 114, the monitoring process continues with the parsing of useful data from the received error alert. Preferably the monitoring tool 76 is configured to filter the amount of information in each error alert to increase the effectiveness of later tracking of error alerts and distribution problems while retaining information useful for creating accurate job tickets. As part of the later updating error alert database step 118, the parsed information may be stored in various locations such as a record in the error alert files 88. Additionally, the parsed information may be stored in numerous configurations and may be contained in files related to each network device (e.g., servers and client network devices) or related to specific types of problems.

To illustrate the type of information that may be parsed, but not as a limitation to a particular data structure arrangement, a record may be provided in the error alert files 88 for each parsed error alert and include an error alert identification field for containing information useful for tracking particular error alerts and a geographic region field for providing adequate location information to allow the monitoring tool 76 to sort the error alerts by geographic region. As shown in FIG. 1, the geographic regions 30, 50 are directly related to the location of the maintenance centers 48, 68. Consequently, the geographic region field is included to allow the monitoring tool 76 to sort the error alerts by maintenance centers 48, 68, which enables job tickets to be transmitted to the maintenance center 48, 68 responsible for servicing the device related to the error alert. In some situations, sorting by geographic region also enables the monitoring tool 76 to produce reports indicating errors occurring in specific geographic regions which may be utilized to more readily identify specific service problems (such as a network link problem in a specific geographic area). In some embodiments, the geographic region information is retrieved by the monitoring tool 76 based on a validated device name and then stored with the other parsed error alert data.

The error alert record further may include a computer server name field for storing the name of the device upon which installation of the distributed package failed. This information is useful for completion of the job ticket to allow maintenance personnel to locate the device. The device name is also useful for checking if the device has been intentionally taken offline (see step 124). Additionally, in some embodiments of the invention, error alert files 88 may include tracking files or records (not shown) for each device monitored by the system 10. Such records may include a field for each type of problem being tracked by the monitoring tool 76 for storing a running total of the number of error alerts received for that device related to that specific problem. When the total count in any of the problem or error fields for a particular device exceeds (or meets) a corresponding threshold limit, the monitoring tool 76 continues the process of verifying whether a job ticket should be created and issued for that device. Use of the threshold limit is discussed in more detail in relation to step 144.

Additional fields that may be included in the record include, but are not limited to, a domain field for the source of the error alert, a failed package field for storing information pertaining to the distributed package, and an announced failure field for storing the initially identified problem. The announced failure field is important for use in tracking the number of error alerts received pertaining to a particular problem (as utilized in step 144) and for inclusion in the created job ticket to allow better service by the maintenance centers 48, 68. An intermediate server name field may be included to allow tracking of the source of the error alert. Additionally, an action taken field may be provided to track what, if any, corrective actions have been taken in response to the error alert. Initially, the action taken field will indicate no action because this information is not part of the parsed information from the error alert. The type and amount of information included in the error alert records may also be dictated by the amount and type of information to be displayed on the user interface 77 during step 150 or included in a report generated in step 154.

To control the number of erroneous job tickets produced, the processing 110 continues at 116 with validation of the received error alert. As can be appreciated, numerous e-mail messages and improper (e.g., not relating to an actual problem) error alerts may be received by the monitoring tool 76, and an important function of the monitoring tool 76 is to filter out the irrelevant or garbage messages and alerts. The steps taken by the monitoring tool 76 may be varied significantly to achieve the functionality of identifying proper error alerts that should be acted upon or at least tracked.

For example, the error alert validation process may include a series of three verification steps beginning with the determination of whether the source of the error alert has a valid domain. For an e-mail error alert, this determination involves comparing the domain of the e-mail error alert with domains included in the domain list 92. The domains in the domain list 92 may be the full domain or Internet address or may be a portion of such domain information (e.g., all information after the first period, after the second period, the like). If the e-mail came from a domain serviced by the system 10, the validation process continues with inspection of the subject line of the e-mail message. If not from a recognized domain, the error alert is determined invalid and processing of the error alert ends at 160 of FIG. 2. Note, the domains in the domain list 92 may be further divided into domains for specific distribution efforts or for specific packages, and the monitoring tool 76 may narrow the comparison with corresponding information in the error alert.

Validation may continue with inspection of the subject line of the error alert in an attempt to eliminate garbage alerts or messages that are not really error alerts. For example, e-mail messages may be transmitted to the monitoring tool 76 that are related to the distribution or the error but are not an error alert (e.g., an end user may attempt to obtain information about the problem by directly contacting the monitoring center 70). To eliminate these misdirected or inappropriate error alerts, the monitoring tool 76 in one embodiment functions to look for indications of inappropriate error alerts such as “forward” or “reply” in the e-mail subject line. The presence of these words indicates the e-mail error alert is not a valid error alert, and the monitoring process 110 is ended at 160.

If the subject line of the error alert is found to be satisfactory, validation at 116 continues with validation of the node name of the device that transmitted the error alert. Typically, the node name is provided as the first part of the network or Internet address. Validation is completed by comparing the node name of the source of the error alert with node names in the node list 94. If the node name is found, the e-mail error alert is validated and processing continues at 118. If not, the error alert is invalidated and monitoring tool 76 ends monitoring 110 of the error alert at 160. Again, the node names in the node list 94 may be grouped by distribution effort and/or application packages. In the above manner, the monitoring tool 76 effectively reduces the number of error alerts used in further processing steps and controls the number of job tickets created and issued.

Referring again to FIG. 2, the error alert monitoring process 110 continues at 118 with the updating of the error alert database 88 (and the failed distribution database 90) with the parsed data from step 114 for the now validated error alert. As noted, these files 88 may include database records of each error alert and preferably include a record for each device serviced by the system 10 for which errors may arise. Hence, updating 118 may involve storing all of the parsed information in records and may include updating the record of the affected network device. For example, the record for the affected network device may be updated to include a new total of a particular error for later use in the processing 110 (such as display on user interface 77 or inclusion of error totals in a generated report in step 154).

At 120, the monitoring tool 76 examines the parsed data from the error alert to determine whether the reported error is for a device, e.g., a server, or a communication or connection problem. Such a determination may include running Packet Internet Groper (PING) on the two IP addresses on either side of the reported down device, e.g., a server, to verify that the network is not causing the error to be generated. At step 120, the monitoring tool 76 may utilize the initial diagnostics 80 to perform a variety of remote diagnostics and/or other processing of the parsed error alert data that applies to both device and network problems. For example, the monitoring tool 76 may sort the errors by domain in order to divide the error alerts into geographic regions 30, 50, which is useful for displays on the user interface 77, report generation, and proper addressing of resulting job tickets.

The monitoring tool 76 may at 120 (or at another time in the process 110), determine if the host or device name is incomplete or inaccurate and if incomplete perform further processing on other fields sent in the alert to completely determine the host or device name. In one embodiment, the monitoring tool 76 will search system 10 log files and check for lockfile flags indicating locking of files pertaining to the affected devices or host. If a lockfile flag exists, this indicates that a prior alert pertaining to that particular host or device is currently being processed, and a sleep or pause processing 110 occurs until the lockfile flag is cleared, which controls interference with that simultaneously occurring fault or error being processed and controls corruption of the error alert files 88, the network files 86, or other files (not shown) for use in displays on the user interface 77 or generated reports. If no lockfile flags are found, processing at 120 may continue with “touching” or setting the lockfile flag for the particular device or host. Any updated or created additional information for the device, host, or network location is preferably stored such as in the error alert files 88, the network files 86, or other files (not shown) for use in displays on the user interface 77 or generated reports.

If the error alert relates to a device, the monitoring process 110 continues at 122 with performance of device-oriented diagnosis and special case routines 82 from memory 78. For example, if the device is a server, the monitoring tool 76 is configured to determine if the server is actually down. In one preferred embodiment, multiple tests are performed to enhance this “down” determination because most existing diagnostics or tests involve UDP protocols and many routers and hubs only give these protocols a best effort-type response that can lead to false down determinations with the use of only a single diagnostic test.

Numerous server-specific tests can be run by the monitoring tool 76. In one embodiment, three tests are performed and if any one of the tests returns a positive result (e.g., the transmitted signal makes it to and back from the server), the server is considered not down and the error alert is not processed further (except for possible storage in the memory 78). The diagnostic tests performed in this embodiment include running Packet Internet Groper (PING) to test whether the device is online, running Traceroute software to analyze the network connections to the server, and performing a rup on the server (e.g., a UNIX diagnostic that displays a summary of the current system status of a server, including the length of up time).

If none of these three tests indicate the device or server is operable, the monitoring process 110 continues at 124 with looking up the device in the outage notice files 104. If the device has been taken out of service for repairs or for other reasons posted in the outage notice files 104, the monitoring process 110 ends at 160 for this error alert. If not purposely taken offline or otherwise identified as a “known outage,” the service ticket mechanism 96 is called at 130 to further process the parsed error alert data and if needed, to create and issue a job ticket to address the problem at the device. The operation of the service ticket mechanism 96 is discussed in further detail below with reference to FIG. 3 and constitutes an important part of the present invention.

If the error alert is determined to concern a network problem (e.g., a PING test indicates a network problem), the monitoring process 110 continues at 140 with the determination of the last accessible IP address on the communication pathway upstream from the “down” device (i.e., the device for which a PING test indicated a network problem). Preferably, the monitoring process 110 is adapted to hold all later “device” down error alerts on the same communication pathway and more particularly, for “down” devices downstream on the communication pathway from the device identified in the first received error alert. For example, with reference to FIG. 1, an error alert may indicate that intermediate server 58 is “down” but a PING test indicates that there is a network problem. In this case, error alerts for “down” devices would be held for a period of time (such as 1 minute or longer although other hold time periods can be used) to minimize processing requirements and control the issuance of false job tickets (e.g., if a network problem occurs upstream of server 58, error alerts from client network devices 62 and 66 most likely also are being caused by the same network problem and do not require another job ticket).

At 142, the network database 86 is updated for the last identified IP address. Specifically, the running count of error alerts indicating a problem for that IP location is increased. The count is compared at 144 with a threshold limit or value, which as stated earlier may be a preset limit or may be altered by an operator via the user interface 77. If the threshold is not exceeded, the monitoring process 110 ends at 160 and awaits the next error alert. If a threshold is exceeded (or in some cases matched), processing 110 continues at 146 with the monitoring tool 76 performing further tests or diagnostics to better identify the problem (such as the network-specific tests 84). The information gained in the diagnostics is passed to the service ticket mechanism for use in creating a job ticket to resolve the network or communication pathway problem. In this fashion, a single “network down” job ticket is issued at step 130 although multiple error alerts were created by the system 10 components thus reducing administrative problems for the maintenance centers 48, 68.

According to one unique feature of the invention, one of the additional network diagnostic tests (or monitoring processes) performed is to initiate or spawn an ongoing or periodic routine that continues to test the network (or “down” device indicated in the error alert) until the problem is corrected. This spawned monitoring routine may be carried out in a variety of ways. In one embodiment, the monitoring tool 76 begins a background routine that continues (e.g., on a periodic basis such as but not limited to once per hour) to PING the “down” device and if still “down,” sends messages, such as email alerts, that indicate the communication pathway to the device is still down to the monitoring tool 76. This spawned monitoring routine remains active until the PING test indicates the device is alive or accessible. The monitoring tool 76 can then use this information to determine the length of time that the network was offline or unavailable. This out of service time can be reported to an operator in real time in a monitoring display on user interface and/or in generated reports.

According to another aspect of the invention, the monitoring tool 76 can be adapted to only continue to step 130 (i.e., calling the service ticket mechanism 96) to issue a ticket once for a particular type of error per a selected time period. For example, multiple error alerts may be received for a connection error on a communication pathway but due to the closeness in time, the monitoring tool 76 operates under the assumption that the errors may be related (retries at distribution of a single package and the like).

In one embodiment, the time period is set at four hours such that only one ticket is initiated by the monitoring tool 76 for a specific device and/or specific error type each four hours. Note that all faults indicated in the error alerts are recorded and logged and this information is preferably provided in the generated reports (and sometimes displayed on user interface 77) to assist operators in accurately assessing faults. In this manner, the monitoring tool 76 effectively filters out identical errors while allowing new, unique errors to trigger the issuance of a job ticket at 130. Note, the monitoring tool 76 is preferably configured to not hold certain error types and to continue to step 130 for each occurrence of these more serious faults, e.g., a valid “down” server error alert may result in a job ticket each time it is received.

Once the job ticket is issued at 130 (or at least the service ticket mechanism 96 is called), the monitoring process 110 continues at 150 with the monitoring tool 76 acting to provide a real time, or at least periodically updated, display of the status of the monitoring process 110 on the user interface 77. For example, the displayed information on the user interface 77 may include a total of the received and processed error alerts sorted by geographic region, by error type, and/or by action takes (e.g., job ticket issued, maintenance paged, resolutions attempted, and the like). The displayed information also preferably includes the information being gathered by any spawned monitoring routines such as the current length of time a network communication pathway or “down” device has been out of service.

The monitoring tool 76 may also provide a number of useful tools that the operator of the user interface 77 may interactively operate. For example, the operator may indicate that the thresholds and time periods discussed above should be altered throughout the system 10 or for select devices, error types, or geographic regions. The operator may also indicate what portions of the parsed and gathered error information should be displayed. Another tool provided by tool 76 is a tracking tool that allows an operator to find out the real time status of a particular job ticket (e.g., if the ticket is still being built, when transmitted, if the ticket is being addressed by maintenance personnel, whether the ticket has been cleared, and the like).

The monitoring process 110 continues at 154 with the generation of a report(s) and the updating of all relevant tracking databases (e.g., to update counts when a ticket is issued, to clear counts for network locations, and other updates). The reports may be issued periodically such as daily or upon request by an operator. The report preferably includes information from the spawned monitoring routine such as date, time report issued, name and location of communication pathway fault, time down or offline, and reference job ticket issued to address the problem.

With an understanding of the general monitoring process 110 understood, a more specific discussion is provided of the operation of the service ticket mechanism 96 when it is called by the monitoring tool 76 at step 130. Referring to FIG. 3, the process 170 of automatically creating and issuing a job ticket begins with the passing of a number of parameters and information to the service ticket mechanism 96. The passed information will include a portion of the information parsed from the error alert(s). Additionally, the passed parameters may be provided automatically by the monitoring tool 76 via data retrievals and look ups based on the parsed information. In one embodiment, an operator is able to select at least some of the passed parameters (such as task type, job ticket priority, and the like). The monitoring tool 76 collects these operator entered parameters through prompts on the user interface 77, which in one embodiment is a command line interface (e.g., at the UNIX command line) but a graphical user interface may readily be employed to obtain this data.

The passed parameters generally include the information that the service ticket mechanism 96 uses to fill in the fields of a job ticket template. Of course, some of the job ticket information may be retrieved by the service ticket mechanism 96 based on the passed parameters (e.g., a passed device identification may be linked to the devices geographical region and/or specific physical location). In one embodiment, the passed parameters include: identification of the affected network device (e.g., a server name and domain); a requested maintenance priority level to indicate the urgency of the problem; a location code (e.g., a building code); a maintenance task type (e.g., for a network problem the task type may be “cannot connect” with a corresponding identifying number and for device problems the task type may be “file access problem,” “system slow or hanging,” “file access problem,” or “device not responding” again with a corresponding identification number); a geographic region or other indication of which maintenance center 48, 68 to send the created job ticket; and other data to be provided with job ticket. The other data parameter allows an operator to pass a text file indicating more fully what is believed to be wrong, what the operator recommends be done, and contact information.

Based on the passed parameters, the service ticket mechanism 96 acts at 174 to retrieve an appropriate job ticket template. For example, a set of templates may be maintained in the system 10 and be specific to various task types, devices, geographical regions, or other selected information or factors. At 176, the service ticket mechanism 96 builds a job ticket by combining the passed parameters and error alert information with the downloaded template to fill in template fields. In one embodiment, the job ticket is formatted for delivery over the network 24 as a e-mail message but numerous other data formats are acceptable within the system 10.

At 178, the service ticket mechanism 96 uses the passed geographic region to select an addressee for receiving the job ticket, such as maintenance center 48 or 68. The device location or building code can also be used in some embodiments of the system 10 to address the job ticket to a queue within a building, and embodiments can be envisioned where a location within a large building may be preferable if there are numerous devices in the building. A passed parameter may indicate that a specific contact person in a maintenance department be emailed and/or paged. In this embodiment, the service ticket mechanism 96 may be configured to transmit an email job ticket to the maintenance center 68 and concurrently e-mail and/or page the maintenance contact. A message (e.g., an e-mail) is also transmitted to the monitoring center 70 for display on the user interface 77 or for other use indicating the creation and issuance of a job ticket (which is typically identified with a reference number).

At 180, the service ticket mechanism 180 determines whether the transmitted job ticket was successfully transmitted and received by the addressee maintenance center 48,68. If not, the service ticket mechanism 96 preferably is configured to retry transmittal at 182. At 184, the service ticket mechanism 180 again determines whether the job ticket was received and if not, returns to 182 to retry transmittal. The service ticket mechanism 96 typically is configured to retry transmittal a selected number of times (such as 2-10 times or more) over a period of time with a set spacing between transmissions (e.g., after 30 seconds, after 5 minutes, after 1 hour, and the like to allow problems in the network to be corrected). If still unsuccessful in transmission, the service ticket mechanism 96 ends its functions at 190 with a notification of failed transmission to the monitoring center 70.

If the job ticket is successfully transmitted, the service ticket mechanism 96 continues to operate at 186 with determining whether the maintenance center 48, 68 or other recipient accepted the transmitted job ticket or rejected the ticket due to an error or fault. If the job ticket was accepted (i.e., all fields were completed as expected), the service ticket mechanism 96 acts at 188 to notify the monitoring center 70. For example, the notification message may include text that indicates a good or acceptable job ticket was created and issued for a specific device or network pathway, how many transmittal tries were used to send the ticket, when and where the ticket was sent, and a job ticket reference number.

According to an important feature of the invention, the service ticket mechanism 96 is configured to process and automatically resolve a number of errors that may result in rejection of a job ticket by a recipient. At 192, the service ticket mechanism 96 processes information provided by the recipient (e.g., maintenance center 48, 68) indicating the error or fault in the transmitted job ticket. If the error cannot be handled by the service ticket mechanism 96, the monitoring center 70 is notified to enable an operator to provide corrected parameters and processing ends at 190.

The type of faults that may be automatically corrected may include, but is not limited to: an invalid building or location code, a server in the pathway or at the maintenance center 48, 68 that is unavailable, bad submission data in a field (e.g., unexpected formatting or values), a process deadlock, and a variety of errors pertaining to a particular operating system and/or software used in the system 10. At 192, the service ticket mechanism 96 first attempts to address the fault or error with the originally transmitted job ticket. For example, if the error was an invalid building or location code, the service ticket mechanism 96 automatically acts to retrieve a known valid building code and preferably one that is appropriate for the affected device (such as by doing a search in the device location files 102). The service ticket mechanism 96 then issues the modified job ticket and returns operation to 180 to repeat the receipt and acceptance determination processes. In this manner, the service ticket mechanism 96 functions to handle administrative details of selecting a ticket template, filling the template fields with passed parameters, and addressing commonly occurring errors automatically to reduce operator involvement and increase the efficiency of the monitoring system 10.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, the monitoring tool 76 may readily be utilized with multiple software distribution tools 18 and a more complex network than shown in FIG. 1 that may include more geographic regions and intermediate servers and client network devices and combinations thereof. Similarly, the descriptive information and/or strings collected from the error alerts and included in the created job tickets may also be varied.

Further, in one embodiment, the service ticket mechanism 96 operates prior to issuing a ticket at 178 to verify the accuracy of at least some of the information parsed from the error alert prior to creation of the job ticket. Specifically, the mechanism 96 operates to cross check the name and/or network address of the device and the location provided in the error alert with the location and device name and/or network address provided in the device location files 102, which are maintained by system administrators indicating the location (i.e., building and room location of each device connected to the network serviced by the system 10). The device name often will comprise the MAC address and the IP address to provide a unique name for the device within the network. If the name is matched but the location information is not matched, the service ticket mechanism 96 may function to retrieve the correct location information from the device location files and place this in the error alert files 88 for this particular device.

We claim:

1. A computer-implemented method for monitoring processing of and response to error alerts, the error alerts being created during package distribution on a computer network comprising a plurality of network devices linked by communication pathways and including information related to package distribution failure, the method comprising:
receiving an error alert;
processing the error alert to create a subset of error data from the failure information including an identification of an affected one of the network devices;
determining whether the error alert was generated due to an operating status of the identified network device or due to a fault in one of the communication pathways by remotely performing a diagnostic test on the identified network device;
based on the determining, performing diagnostics on the identified network device or the communication pathway that caused generation of the error alert; and
creating a job ticket to initiate device or network service, wherein the job ticket includes at least a portion of the failure information from the error alert and information gathered in the diagnostics performing.

2. The method of claim 1, wherein the determining includes running Packet Internet Groper (PING) on an IP address on a first side of the identified network device and on an IP address on a second side of the identified network device.

3. The method of claim 1, wherein the error alert was generated due to a fault in one of the communication pathways, and the method further including determining a last accessible IP address in the communication pathway, incrementing a fault count for the last accessible IP address, and determining whether the incremented fault count exceeds a threshold, wherein the job ticket creating is only performed when the threshold is exceeded.

4. The method of claim 1, wherein the error alert was generated due to an operating status of the identified network device and wherein the diagnostics performing includes performing a series of device-oriented tests.

5. The method of claim 4, wherein the job ticket creating is performed only when each of the series of device-oriented tests indicates the identified network device is faulting and wherein the series includes running Packet Internet Groper (PING) on the identified network device, running rup on the identified network device, and running Traceroute software to analyze network connections to the identified network device.

6. The method of claim 4, wherein the method further includes determining whether the identified network device is included on an outage list, and further wherein the job ticket creating is not completed when the identified network device is determined to be included on the outage list.

7. The method of claim 1, further including providing a display on a user interface of a portion of the subset of error data from the error alert processing and status of the job ticket creating.

8. The method of claim 7, wherein when the error alert was generated due to a fault in one of the communication pathways, at least periodically checking the communication pathway that caused the generation of the error alert for faults, and wherein results of the checking are included in the display on the user interface.

9. A service monitoring method, comprising:
receiving an error alert for a device in a computer network, wherein the error alert includes identification and network location information for the device;
creating a check engine to at least periodically transmit a signal to the device to determine if the device is active; and
when the check engine determines the device is active, transmitting a device active message to a user interface for display.

10. The method of claim 9, further including determining a down time for the device based on information gathered by the check engine and transmitting the down time to the user interface for display.

11. The method of claim 9, wherein the check engine includes running Packet Internet Groper (PING) on the device to identify when the device becomes active.

12. The method of claim 9, further including prior to the creating, determining a last accessible IP address in the computer network upstream of the device, incrementing a fault count for the determined last accessible IP address, comparing the fault count with a fault threshold, and when the comparing indicates the fault count exceeds the fault threshold, issuing a job ticket to a maintenance center associated with the device.

13. The method of claim 12, further including prior to the job ticket issuing, performing diagnostic tests on the device and computer network, wherein information gathered in the performing is included in the issued job ticket.

14. A method for responding monitoring operation and maintenance of communication pathways and network devices in a computer network, comprising:
receiving an error alert from one of the network devices;
processing the error alert to retrieve a set of service information including identification of an affected one of the network devices;
determining a maintenance center corresponding to the identified network device based on the retrieved service information;
selecting and retrieving a job ticket template based on the service information;
creating a job ticket for the identified network device by combining the retrieved job ticket template and at least a portion of the service information; and
transmitting the created job ticket to the corresponding maintenance center.

15. The method of claim 14, including when the transmitting is unsuccessful, repeating the transmitting a predetermined number of times over a set period of time.

16. The method of claim 14, including after the transmitting, receiving the transmitted job ticket from the corresponding maintenance center with an error and further including modifying the transmitted job ticket based on the error and repeating the transmitting with the modified job ticket.

17. The method of claim 16, wherein the selected job ticket template comprises data fields and the job ticket creating comprises selecting portions of the service information and inserting the selected portions in the data fields and wherein the modifying based on the error comprises altering the inserted selected portions.

18. The method of claim 14, further including periodically transmitting a job ticket status message to a monitoring center and displaying a portion of the job ticket status message in a user interface.

19. A service support system for at least partially automatically processing error alerts created in a distributed computer network in response to a failure during distribution of a software package to network devices and for selectively creating and issuing job tickets to correct the failure, comprising:
a memory device for storing diagnostics for communication pathways and for network devices;
a monitoring tool in communication with the network devices to receive the error alerts and with the memory device to access the diagnostics, wherein the monitoring tool is configured to process each of the error alerts to parse service information, to determine if the failure is caused by a fault in one of the communication pathways or by a operation problem at one of the network devices and to select and remotely perform select ones of the diagnostics based on the determination of the cause of the failure; and
a service ticket mechanism linked to the monitoring tool and configured for receiving a request for a job ticket to initiate service for the determined cause of the failure and for processing the service information and diagnostic information collected by the monitoring tool to create and issue the requested job ticket.

20. The system of claim 19, wherein the monitoring tool is further configured to establish a check process when the request of a job ticket is based on a determination that the failure is caused by a fault in one of the communication pathways, the check process at least periodically sending a message on the one of the communication pathways when the one becomes active.

21. The system of claim 20, further including a user interface in communication with the monitoring tool and wherein the checking process is adapted to determine a length of time inactive for the one of the communication pathways and to transmit an active alert message to the user interface for display including the inactive length of time upon determining that the one is active.

22. The system of claim 19, wherein the memory device is further adapted for storing an outage listing comprising identification information for each of the network devices that are being serviced and wherein the service ticket tool is further operable to only create the job ticket after determining the identified network device is not on the outage listing.

23. The system of claim 19, wherein the memory device is further adapted for storing a device location information comprising a geographic location for each of the network devices and wherein the service ticket tool is further operable to compare location information included in the error alert with the geographic location information in the device location information and to modify the included location information for use in creating the job ticket.
